(19) United States
(12) Patent Application Publication
(10) Pub. No.: US 2017/0305515 A1
(43) Pub. Date: Oct. 26, 2017

(54) PET FLOTATION AND SAFETY VEST DEVICE

(71) Applicant: Kyle Hansen, Castle Rock, CO (US)

(72) Inventor: Kyle Hansen, Castle Rock, CO (US)

(21) Appl. No.: 15/136,969

(22) Filed: Apr. 24, 2016

(51) Int. Cl. B63C 9/08; A01K 29/00

(52) U.S. Cl. CPC B63C 9/08; A01K 29/00; B63C 2009/084

(57) ABSTRACT

The invention relates to a novel pet flotation and safety vest device wherein the body section attaches firmly yet comfortably to the pet, and strategically placed mesh panels allow for water drainage. A padded chip strap aids in keeping the pet's head above water. The vest is adjustable for varying sizes of dogs.

### FIELD

The invention relates to a novel pet flotation and safety vest device wherein the body section attaches firmly yet comfortably to the pet, and strategically placed mesh panels allow for water drainage. A padded chip strap aids in keeping the pet's head above water.

### BACKGROUND OF THE INVENTION

The invention most closely corresponds with USPTO Class 119/174 wherein Class 119 relates to animal husbandry and sub-class 174 includes miscellaneous animal items not included in any specific sub-class.

In its simplest form, the invention relates to a novel pet flotation and safety vest device. Essentially a life vest or life preserver for dogs.

The inventive vest is designed not only for optimal floatation, it is also designed to allow water to drain from the vest whereas many pet life vests simply become saturated and floatation is hampered as well as retrieving the pet from the water source is more difficult due to the weight.

A unique feature of the pet floatation and safety device is a separate padded chin strap which aids in holding the pet's head above water. This chin strap also has mesh panels to allow for easy drainage. A reinforced handle is located on the top of the vest for the pet owner to readily grasp and pull the animal from the water without fumbling with a handhold or potentially having the vest material tear.

### THE INVENTION

### Summary, Objects and Advantages

Many dogs don't swim well or naturally and can drown as fast (or faster) than a person. Depending on the breed, the dog can tire easily in water so it is imperative that a pet owner bringing their dog along during water activities should always have the pet secured with a life preserving means.

Even dogs that swim well can tire very quickly, and because they don't understand the concept of resting or treading water—they just continue to swim until they are completely unable to swim any longer. A dog that is heavy on land is going to be much heavier when wet, and thus may be difficult for the pet owner to pull to safety. A flotation device is crucial not only for floatation, but also to aid in rescuing a waterborne dog.

Dogs that swim in large bodies of water such as large lakes or the ocean can also easily be pulled by the water's current. This is especially true of the ocean. Having a life vest allows the dog to float with the current or tides until the pet owner can safely rescue them.

There are many pet life vests on the market, but the problem with most is that they do not drain easily or they are not configured in such a way as to accommodate varying sizes of dogs. Another problem with current life vests is that they do little to promote the pet's head remaining well above the water. When a dog tires its head will want to naturally droop. This can easily lead to drowning. Most life vests on the market use a one-size fits all model which doesn't allow for specific anatomical consideration related to the animal's weight, rate of fatigue, keeping the dog's head well above the water surface, and efficient drainage of the vest.

Further to the lack of a separate chin strap section of life vests currently on the market is that most vests simply have a section which fits under a dog's chin, but is constructed into the vest as a one-piece continuous section of fabric. This method is not adjustable and thus is not optimized for dogs of various sizes. Nor does this construction offer optimum head buoyancy so that a tired dog can still keep its head above water. The inventive vest has an adjustable chin floatation section which adjusts to the dog as well as contains mesh for drainage of the chin flotation section as does the mesh in the body of the vest.

### BRIEF DESCRIPTION OF THE DRAWINGS

The invention is described in further detail by reference to nine (9) drawings sufficient in detail to describe the invention in which:

FIG. 1 shows the vest from the underside;

FIG. 2 illustrates the vest as fitted onto a dog;

FIG. 3 is a side perspective of the vest, straps, and chin section;

FIG. 4 illustrates the side perspective of FIG. 3 with a dog in phantom;

FIG. 5 is a top perspective of the vest;

FIG. 6 is a side perspective with a dog in phantom illustrating the “grab strap” or handle;

FIG. 7 is an underside view showing the mesh drainage sections;

FIG. 8 is a side perspective illustrating the drainage sections;

FIG. 9 is a top perspective to illustrate the drainage sections.

### DETAILED DESCRIPTION, INCLUDING BEST MODES OF CARRYING OUT THE INVENTION

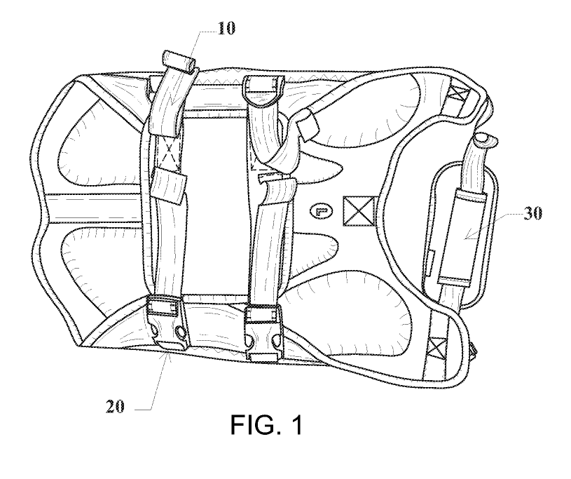

FIG. 1 shows the underside of the vest. Two adjustable nylon belly straps 10 are shown with quick release buckles 20. The underside of the adjustable nylon chin strap 30 is illustrated

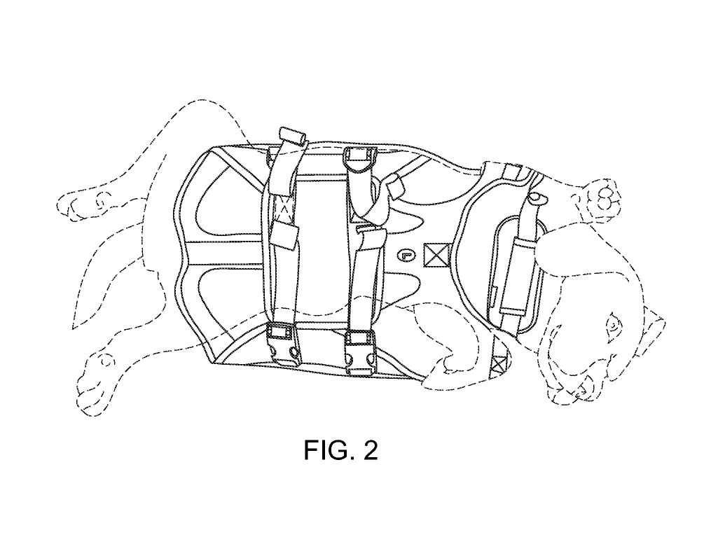

FIG. 2 shows the vest with a dog in phantom to clearly illustrate what the attached vest will look like from the underside view as in FIG. 1.

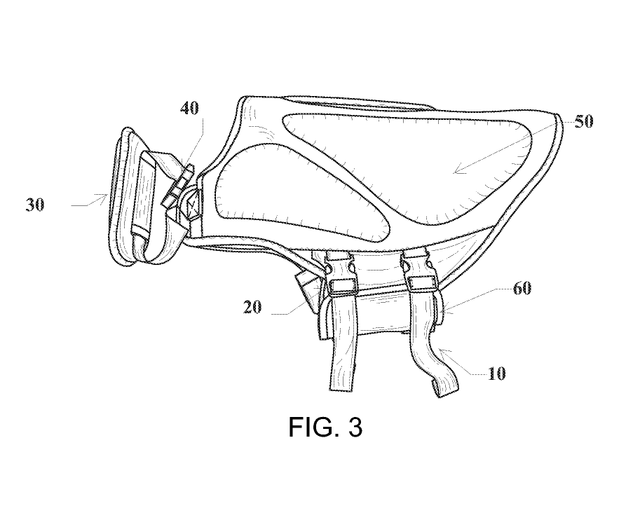

FIG. 3 is a perspective view of the vest with the nylon chin flotation strap 30 shown as contains buoyant material as well as the adjustment point 40 for the chin strap. Again the adjustable belly straps 10 are shown with the quick release buckles 20 attached. Buoyant material fills two extruding sections 50 on the side of the vest. These are flotation sections. A wide under-belly section 60 is shown which provides support and comfort for the dog, and is adjustable in concert with the belly straps 10 and quick release buckles 20.

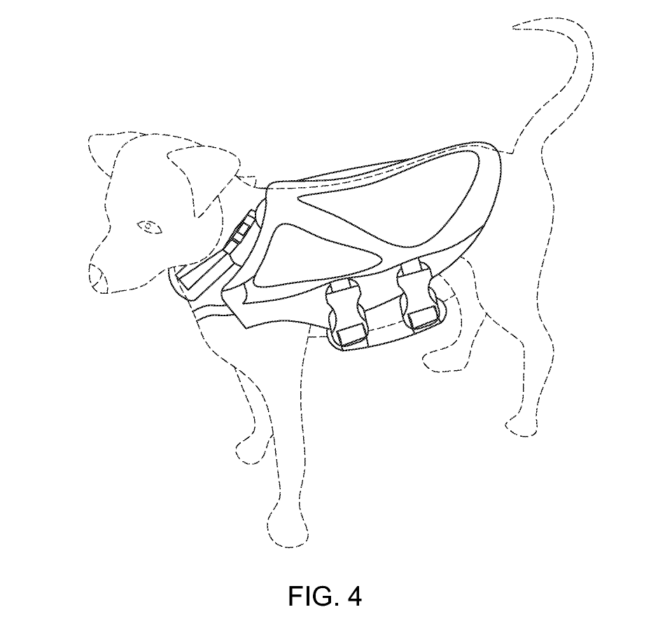

FIG. 4 shows the vest with a dog in phantom to clearly illustrate the perspective view as in FIG. 3 wherein the reader can easily see the fit as would be when the vest is attached to a dog.

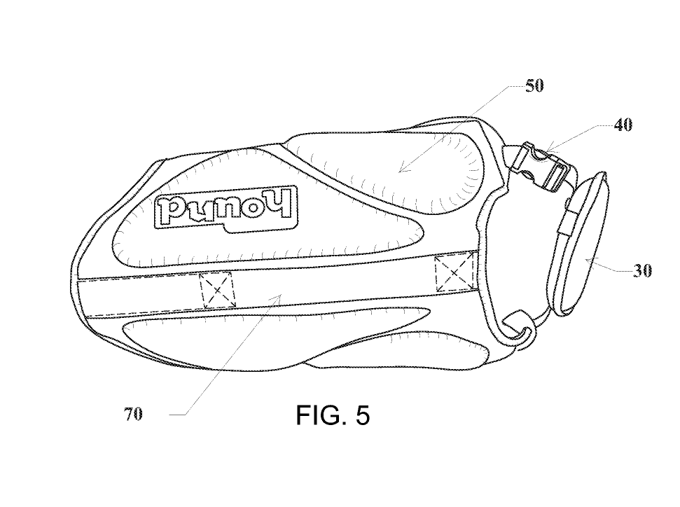

FIG. 5 is a top perspective of the vest and illustrates again the flotation sections 50 and the chin strap 30. This Figure also shows the chin strap attachment point 40 which is a quick release buckle. A reinforced stitched handle or “grab strap” 70 is located on top of the vest so that the pet owner can easily grasp the handle and pull a dog from the water. This strap is reinforced to compensate for the weight of a wet dog and will not rip away from the vest itself even with significant weight opposing the strap.

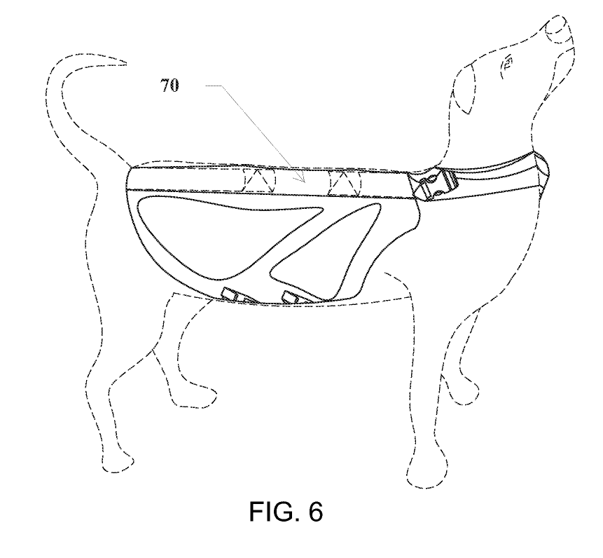

FIG. 6 is a perspective view with a dog in phantom to illustrate the reinforced handle or “grab strap” 70 as would approximate the example when the vest is attached to a dog.

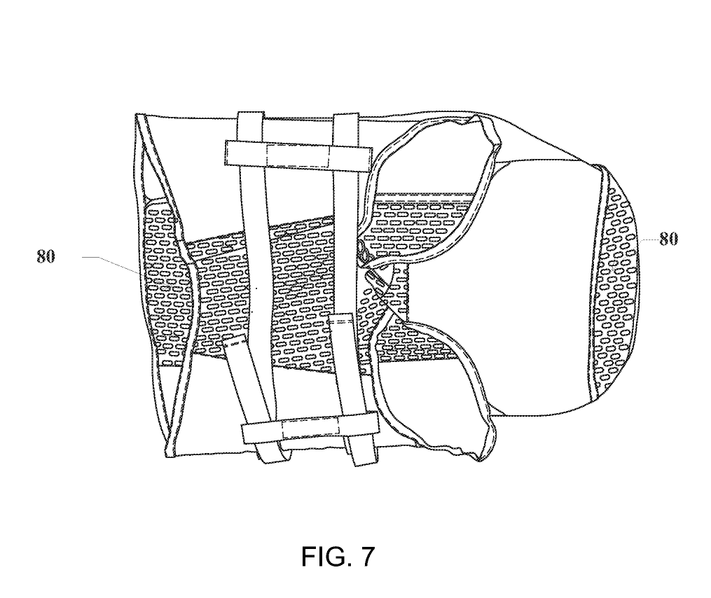

FIG. 7 addresses the mesh drainage sections 80 as per one of the preferred embodiments of the vest. These mesh sections allow for quick water drainage both for the safety of the pet by reducing the weight of a saturated vest, and for ease of pulling the pet from the water. The mesh sections 80 are located both at the top and the underside of the vest. The chin strap is not shown in this Figure for greater clarity re the mesh drainage sections.

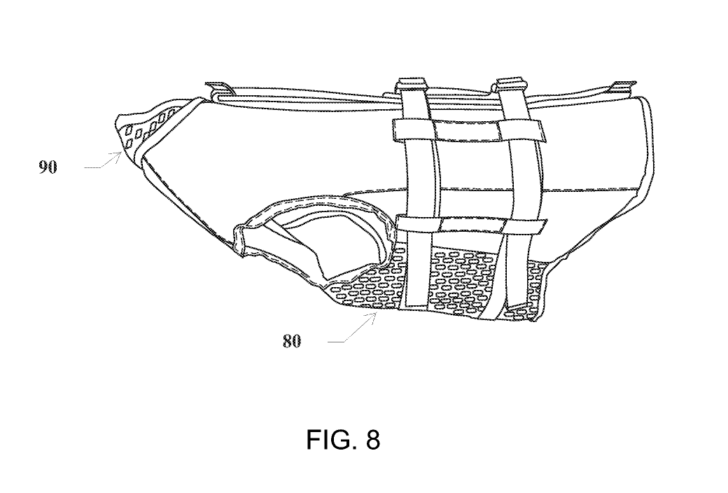

FIG. 8 is a side perspective showing the underside mesh drainage section 80. Also located under the section where the chin strap would be attached is another section of mesh for drainage 90.

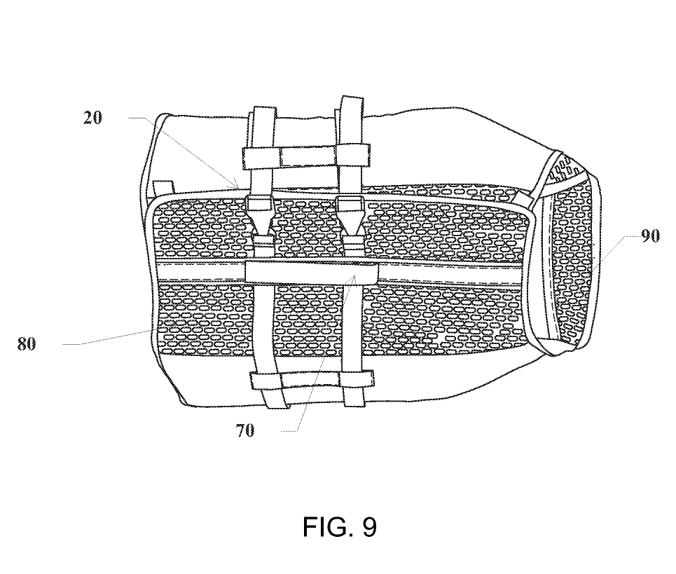

FIG. 9 is top perspective of the vest showing the mesh drainage sections 80 and the reinforced “grab strap” 70. The mesh chin section is also illustrated for clarity. The chin flotation section is not shown in this view.

1) A pet flotation and safety vest device comprising:
a) Neoprene fabric comprises the body of the vest;
b) 2 adjustable nylon belly straps with quick release buckles;
c) 4 body sections containing buoyant material;
d) An adjustable nylon chin strap containing buoyant material;
e) A reinforced nylon handle or “grab strap” on the top side of the device;
f) Mesh sections for drainage.

2) The pet flotation and safety vest device as in claim 1 wherein the material for the body of the vest is Neoprene.

3) The pet flotation and safety vest device as in claim 1 wherein the nylon adjustable belly straps are made so that a length of the strap may be pulled outward or inward depending on the size of the dog, and wherein 2 quick release buckles affix the straps around the belly of the dog.

3) The pet flotation and safety vest device as in claim 1 wherein the neoprene body of the vest contains at least 4 sections wherein buoyant material resides therein for floatation and said sections shall extrude farther outward than the sections without buoyant material therein.

4) The pet flotation and safety vest device as in claim 1 wherein a nylon and neoprene chin strap contains buoyant material and is adjustable by extending or retracting a portion of the nylon strap depending on the size of the dog, and wherein said strap connects via a quick release buckle.

5) The pet flotation and safety vest device as in claim 1 wherein a nylon handle or “grab strap” is reinforceably located on the top side of the vest via a criss-cross stitch pattern whereby a pet owner may pull a wet dog out of the water easily without ripping the strap from the body of the vest.

6) The pet flotation and safety vest device as in claim 1 wherein mesh sections of fabric are located on the top and underside of the vest, and wherein a further section of mesh is located underneath the chin strap so that the vest will not remain saturated while the dog is in the water, and so that the vest will drain quickly upon removal of the dog from the water.
